(19) United States
(12) Patent Application Publication
(10) Pub. No.: US 2005/0118299 A1
(43) Pub. Date: Jun. 2, 2005

(54) Companion animal compositions comprising short chain oligofructose

(75) Inventors: Robert Jason Vickers, Dayton, OH (US); Thomas William-Maxwell Boileau, Springfield, OH (US); Gregory Dean Sunvold, Lewisburg, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The IAMS Company

(21) Appl. No.: 10/725,251

(22) Filed: Dec. 1, 2003

(51) Int. Cl. A01K 1/00

(52) U.S. Cl. 426/2

(57) ABSTRACT

Disclosed are companion animal compositions comprising from about 0.01% to about 0.2% of short chain oligofructose, by weight of the composition, wherein the short chain oligofructose comprises 1-kestose, nystose, and 1F-beta-fructofuranosylnystose. Further disclosed are various methods of using such compositions, including methods of enhancing gastrointestinal health of the companion animal or improving fecal odor of the feces of the companion animal.

### FIELD OF THE INVENTION

The present invention is directed to companion animal compositions comprising specifically defined levels of short chain oligofructose, as well as methods of using such compositions in a companion animal.

### BACKGROUND OF THE INVENTION

Various issues can occur in the companion animal that lead to poor gastrointestinal health. For example, it has been previously described that small intestinal bacterial overgrowth (IBO) occurs in people and companion animals such as dogs, cats, and horses. This may be caused by poor motility, retention of food, decreased gastric acidity or surgical bypass of the stomach. IBO may also be idiopathic. Companion animals affected with IBO may have clinical signs compatible with severe small intestinal disease such as diarrhea and weight loss. Currently, certain therapies may involved removing the cause of the bacterial overgrowth through surgery or administering various antibiotics, such as tetracycline or tylosin.

It has previously been described that the administration of compositions containing fermentable fibers may be useful for the treatment of IBO and other gastrointestinal health issues. See e.g., Reinhart, U.S. Pat. No. 5,776,524 (1998). In general, fermentable fibers are not digested by mammals but may be metabolized by intestinal bacterial species, such as Bifidobacterium. However, not all intestinal bacteria can metabolize fermentable fiber. In particular, bacteria such as Salmonella, E. coli and Clostridia are unable to process such fiber to any meaningful degree. This preferential digestibility, which is applicable for fermentable fiber as a class, can be used to improve the overall bacterial flora in the small intestine of the companion animal. Because fermentable fibers will only feed “good” bacteria such as Lactobacillus and Bifidobacterium, the amounts of harmful bacteria such as Salmonella, E. coli and Clostridia may decrease due to a reduction in food resources. Therefore, by providing a preferred food source for beneficial bacterial species, a diet supplemented with fermentable fiber can increase “good” intestinal bacteria while reducing the amount of “bad” bacteria.

U.S. Pat. No. 5,776,524 describes the use of various fructooligosaccharides for the improvement of gastrointestinal health at various relatively high levels. The compositions described in this patent provide a therapeutically effective means to treat issues associated with compromised gastrointestinal health. However, as is acknowledged in U.S. Pat. No. 5,952,033, the fructooligosaccharide which has been used in certain high quality foods such as those marketed under the EUKANUBA trademark (short chain fructooligosaccharide) is quite expensive and therefore the use of such component has been limited to such premium foods.

However, it is the surprising and exciting discovery by the present inventors that lower levels of a particular fructooligosaccharide, as defined herein, may be utilized while still achieving the benefits provided by the compositions described in U.S. Pat. No. 5,776,524. This is an unexpected benefit since the minimal levels described herein would not have been expected to provide therapeutic benefits. These and other benefits of the present invention are described herein.

### SUMMARY OF THE INVENTION

The present invention is directed to companion animal compositions comprising from about 0.01% to about 0.2% of short chain oligofructose, by weight of the composition, wherein the short chain oligofructose comprises 1-kestose, nystose, and 1F-beta-fructofuranosylnystose. The invention is further directed to various methods of using such compositions, including methods of enhancing gastrointestinal health of the companion animal or improving fecal odor of the feces of the companion animal.

### DETAILED DESCRIPTION OF THE INVENTION

Various documents including, for example, publications and patents, are recited throughout this disclosure. All such documents are hereby incorporated by reference.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments and/or individual components are disclosed. As will be apparent to the ordinarily skilled practitioner, all combinations of such embodiments and components are possible and can result in preferred executions of the present invention.

The compositions herein may comprise, consist essentially of, or consist of any of the components as described herein.

While various embodiments and individual components of the present invention have been illustrated and described, various other changes and modifications can be made without departing from the spirit and scope of the invention. As will be also be apparent, all combinations of the embodiments and components taught in the foregoing disclosure are possible and can result in preferred executions of the invention.

### Companion Animal Compositions of the Present Invention

The present companion animal compositions are compositions comprising from about 0.01% to about 0.2% of short chain oligofructose, by weight of the composition, wherein the short chain oligofructose comprises 1-kestose, nystose, and 1F-beta-fructofuranosylnystose.

Short chain oligofructose is a class of fiber within the broad family of fructooligosaccharides. Fructooliogosaccharides are naturally occurring compounds which can be found in a variety of fruits or vegetables including banana, barley, garlic, honey, onion, rye, brown sugar, tomato, asparagus, artichoke, wheat, yacon, or chicory. Generally, fructooligosaccharide may for example be provided as chicory root, as a long chain oligofructose (e.g., inulin), or as short chain oligofructose. While fructooligosaccharides can be extracted from plants such as those mentioned herein, they can also be formed artificially by adding one, two, or three fructose units to a sucrose molecule by a B-(2-1)-glycosidic linkage of the fructose unit(s) to the fructose unit of sucrose.

As such, short chain oligofructose will be well-known to those of ordinary skill in the art. The short chain oligofructose comprises at least one of 1-kestose (abbreviated as GF₂), nystose (GF₃), and 1F-beta-fructofuranosylnystose (GF₄). In a preferred embodiment, the short chain oligofructose comprises from about 25% to about 45% 1-kestose, from about 25% to about 45% nystose, and from about 1% to about 20% 1F-beta-fructofuranosylnystose, by weight of the short chain oligofructose, alternatively from about 30% to about 40% 1-kestose, from about 50% to about 60% nystose, and from about 5% to about 15% 1F-beta-fructofuranosylnystose, by weight of the short chain oligofructose. As an example, short chain oligofructose is commercially available under the tradename NUTRAFLORA from Golden Technologies Company, Incorporated (which is a short chain oligofructose comprising about 35% 1-kestose, 55% nystose, and 10% 1F-beta-fructofuranosylnystose, all by weight of the short chain oligofructose).

In an embodiment herein, the short chain oligofructose, or any other fermentable fiber included in the composition, (collectively referenced as the fermentable fibers, for simplicity; see below for further discussion of fermentable fibers and other fiber sources which are additional to the short chain oligofructose) may display certain organic matter disappearance percentages. In this optional embodiment, the fermentable fibers may have an organic matter disappearance (OMD) of from about 15% to about 60% when fermented by fecal bacteria in vitro over a 24 hour period. That is, from about 15% to about 50% of the total organic matter originally present is fermented and converted by the fecal bacteria. The organic matter disappearance of the fibers is alternatively from about 20% to about 50%, alternatively from about 30% to about 40%.

Thus, in vitro OMD percentage may be calculated as follows:
((1−(OM residue−OM blank)/original OM))×100
where OM residue is the organic matter recovered after 24 hours of fermentation, OM blank is the organic matter recovered in corresponding blank tubes (i.e., tubes containing medium and diluted feces, but no substrate), and original OM is that organic matter placed into the tube prior to fermentation. Additional details of the procedure are found in Sunvold et al., J. Anim. Sci., Vol. 73, pp. 1099-1109 (1995).

The present inventive companion animal compositions comprise from about 0.01% to about 0.2% of the short chain oligofructose, by weight of the composition. Alternatively, the compositions may comprise from about 0.05% to about 0.19% of the short chain oligofructose, by weight of the composition. Further alternatively, the compositions may comprise from about 0.1% to about 0.18% of the short chain oligofructose, by weight of the composition. Even further, the compositions may comprise from about 5% to about 18% of the short chain oligofructose, or from about 10% to about 16% of the short chain oligofructose, all by weight of the composition.

In a particularly preferred embodiment herein, the compositions are substantially free of inulin and/or chicory (also commonly referenced as chicory root). As used herein, “substantially free of,” with reference to the material, means that the composition comprises less than about 0.1% of the referenced material, more preferably less than about 0.05% of the referenced material, even more preferably less than about 0.01% of the referenced material, even more preferably less than about 0.005% of the referenced material, all by weight of the composition.

Optionally, the composition herein may be a food composition such as a dry composition (for example, kibble), semi-moist composition, wet composition, or any mixture thereof. Alternatively or additionally, the composition is a supplement, such as a gravy, drinking water, yogurt, powder, suspension, chews, treats (e.g., biscuits) or any other delivery form.

Moreover, in a preferred embodiment the composition is nutritionally balanced. As used herein, the term “nutritionally balanced,” with reference to the companion animal composition, means that the composition has known required nutrients to sustain life in proper amounts and proportion based on recommendations of recognized authorities in the field of companion animal nutrition.

The compositions herein may optionally comprise one or more further components. Other components are beneficial for inclusion in the compositions used herein, but are optional for purposes of the invention. For example, as stated, food compositions are preferably nutritionally balanced. In one embodiment, the food compositions may comprise, on a dry matter basis, from about 20% to about 50% crude protein, alternatively from about 20% to about 40% crude protein, by weight of the food composition, or alternatively from about 20% to about 35% crude protein. The crude protein material may comprise vegetable proteins such as soybean, cottonseed, and peanut, or animal proteins such as casein, albumin, and meat protein. Non-limiting examples of meat protein useful herein include a protein source selected from the group consisting of beef, pork, lamb, poultry, fish, vegetable, and mixtures thereof.

Furthermore, the compositions may comprise, on a dry matter basis, from about 5% to about 40% fat, alternatively from about 10% to about 35% fat, by weight of the food composition.

The compositions of the present invention may further comprise a source of carbohydrate. Grains or cereals such as rice, corn, milo, sorghum, barley, alfalfa, wheat, and the like are illustrative sources.

The compositions may also contain other materials such as dried whey and other dairy by products.

The compositions may further comprise a fiber source additional to the short chain oligofructose. A variety of soluble or insoluble fibers may be utilized, which will be well-known to those of ordinary skill in the art. In one embodiment, at least a portion of the fiber source is selected from the group consisting of beet pulp (from sugar beet), gum arabic, gum talha, psyllium, rice bran, carob bean gum, citrus pulp, pectin, fructooligosaccharide additional to the short chain oligofructose, mannanoligofructose, soy fiber, arabinogalactan, galactooligosaccharide, arabinoxylan, and mixtures thereof.

In one embodiment, the additional fiber source comprises a fermentable fiber. Fermentable fibers are not digested by mammals but may be metabolized by intestinal bacterial species, such as Bifidobacterium. However, not all intestinal bacteria can metabolize fermentable fiber. In particular, bacteria such as Salmonella, E. coli and Clostridia are unable to process such fiber to any meaningful degree. This preferential digestibility, which is applicable for fermentable fiber as a class, can be used to improve the overall bacterial flora in the small intestine of the companion animal. Because fermentable fibers will only feed “good” bacteria such as Lactobacillus and Bifidobacterium, the amounts of harmful bacteria such as Salmonella, E. coli and Clostridia may decrease due to a reduction in food resources. Therefore, by providing a preferred food source for beneficial bacterial species, a diet supplemented with fermentable fiber can increase “good” intestinal bacteria while reducing the amount of “bad” bacteria.

Beet pulp and fructooligosaccharide additional to the short chain fructooligosaccharide are particularly preferred fermentable fibers for use herein. The additional fructooligosaccharide may for example be provided as chicory root, or as a long chain oligofructose (e.g., inulin). In one example, a mixture of short chain fructooligosaccharide and inulin can be PREBIO1 or a mixture of commercially available RAFTILOSE and RAFTILINE.

The compositions may optionally comprise a total dietary fiber level of from about 0.001% to about 30%, alternatively from about 0.01% to about 20%, or alternatively from about 1% to about 16% total dietary fiber, by weight of the composition.

### Methods of the Present Invention

The methods of the present invention comprise orally administering (i.e., through ingestion) a composition of the present invention to a companion animal to provide improvement in gastrointestinal health and/or improvement in the fecal odor of the feces of the companion animal, as applicable. In one embodiment herein, the enhancement of gastrointestinal health may include any one or more of the following benefits: therapeutically relieving the symptoms of, or prevention of, gastrointestinal inflammatory disorders, inflammatory bowel disease, diarrhea or loose stools; otherwise improving fecal quality; weight loss associated with diarrhea or loose stools; treatment of small intestine bacterial overgrowth; or manipulation of levels of bacteria including improving levels of beneficial bacteria relative to harmful bacteria and/or decreasing pathogenic bacteria. Moreover, ancillary benefits to improvement in the fecal odor of the feces of the companion animal include removal of putrefactive substances which are known to promote, either directly or indirectly, carcinogenic effects in the mammalian system. Therefore, reducing pro-carcinogenic substances or effects, specifically reducing risk of cancer, is a useful benefit herein. Various methods of analysis directed to these benefits are described herein below.

As used herein, the term “orally administering” with respect to the companion animal means that the animal ingests or a human is directed to feed, or does feed, the animal one or more compositions herein. Wherein the human is directed to feed the composition, such direction may be that which instructs and/or informs the human that use of the composition may and/or will provide the referenced benefit, for example, an improved gastrointestinal health benefit. For example, such direction may be oral direction (e.g., through oral instruction from, for example, a veterinarian or other health professional), radio or television media (i.e., advertisement), or written direction (e.g., through written direction from, for example, a veterinarian or other health professional (e.g., scripts), sales professional or organization (e.g., through, for example, marketing brochures, pamphlets, or other instructive paraphernalia), written media (e.g., internet, electronic mail, or other computer-related media)), and/or packaging associated with the composition (e.g., a label present on a container holding the composition). As used herein, “written” means through words, pictures, symbols, and/or other visible descriptors. Such information need not utilize the actual words used herein, for example, “gastrointestinal”, “companion”, or “adapted for use”, but rather use of words, pictures, symbols, and the like conveying the same or similar meaning are contemplated within the scope of this invention.

The compositions described herein may be used as a supplement to ordinary dietetic requirements or may serve as the primary food for the companion animal (and, as such, the supplements or foods may be nutritionally balanced). Administration may be on as as-needed or as-desired basis, for example, once-monthly, once-weekly, or daily (including multiple times daily). When utilized as a supplement to ordinary dietetic requirements, the composition may be administered directly to the companion animal or otherwise contacted with or admixed with companion animal food. When utilized as a companion animal food, administration will be well-known to those of ordinary skill. The amount of composition utilized may be dependent on a variety of factors, including the quality of gastrointestinal health of the animal, preference of the animal as determined by the guardian of the animal or other person administering the composition, the quality of the companion animal food, and size or breed or the companion animal.

### Methods of Analysis

The present compositions may be utilized to enhance the gastrointestinal health of the companion animal or improve fecal odor of the feces of the companion animal. Various methods of demonstrating such enhancements or improvements are well-known to those of ordinary skill in the art. As examples, the following provides illustrations of certain methods which may be used. These methods are not intended to limit the scope of the invention.

Methods of Enhancing Gastrointestinal Health: Methods of measuring enhancements in gastrointestinal health of a companion animal will be well-known to those having ordinary skill in the art. An illustrative example of making such measurements is set forth in U.S. Pat. No. 5,952,033, which follows the general method described above with respect to measurement of fecal odor, with the following modifications: The levels of short chain fatty acids in the fecal matter are determined by gas chromatograph. The results indicate that administration of the test food results in increased short chain fatty acid concentrations relative to administration of the control food, which is believed to contribute to improved gastrointestinal health.

Additionally or alternatively, the compositions herein may be measured by their ability to reduce the amount of harmful bacteria in the small intestine (also referenced as treating small intestinal bacterial overgrowth, or IBO). Such methods are described in Reinhart, U.S. Pat. No. 5,776,524 (1998).

Additionally or alternatively, as one of ordinary skill in the art will recognize, fecal matter quality may also be indicative of gastrointestinal health. The treatment or prevention of gastrointestinal infection, including diarrhoea, in companion animals may be measured using stool scores. Stools scores may be recorded daily according to the following guidelines and control and test groups compared before and after administering the compositions according to the present invention.

Score: 5 Extremely Dry

This stool is hard and does not stick to surfaces. Stool will roll when pushed. No indentations are made when stool is picked up. Stool is often defecated in groups of individual stools instead of one complete unit. The stool maintains original shape after collection.

Score: 4 Firm (Ideal Stool)

This stool is firm, well shaped, and cylindrical. This stool does not break apart easily when picked up. This stool may leave residue on surfaces and gloves. This stool is often defecated as one unit. The stool maintains original shape after collection.

Score: 3 Soft, with Shape

This stool is soft, however there are definite shapes. This stool will break apart easily and will definitely leave residue on surfaces and gloves. The stool often loses original shape after collection. This stool is often present with another score but can comprise whole stool sample.

Score: 2 Soft, without Shape

This stool is soft and will have no cylindrical shape. The shape often associated with a “2” is a “cow patty” shape. This stool will lose the original shape when collected and will definitely leave residue on surfaces and gloves. This stool score is often present with another score but can comprise the whole stool sample. This stool sample may spread over an area of several inches.

Score: 1 Liquid

This stool score will always resemble liquid and there may or may not be particulate matter present. This stool will often be defecated in groups of piles instead of one complete unit. Mucous is often present with this stool sample. This stool sample is very difficult to collect and residue is always left on surfaces and gloves. This stool sample may spread over an area of several inches.

In addition, other observations are also recorded, including: blood in stool; foreign object in stool; or mucous in stool.

Furthermore, the enhancement of gastrointestinal health in companion animals may comprise improving microbial ecology of companion animals. Improving the microbial ecology of companion animals preferably comprises reducing the levels of pathogenic bacteria in the feces of companion animals. The levels of pathogenic bacteria present in the feces of companion animals may be enumerated using the standard plate count method known to those skilled in the art. More preferably, the pathogenic bacteria are selected from the group consisting of Clostridia, Escherichia, Salmonella, Bacteriodes and mixtures thereof. Non-limiting examples of suitable strains of pathogenic bacteria include B. fragilis, C. perfringens, C. difficile, Eschericia coli, Salmonella typhimurium and mixtures thereof.

Improvement of Fecal Odor of the Feces of a Companion Animal: Methods of measuring improvement of fecal odor of the feces of a companion animal will be well-known to those having ordinary skill in the art. An illustrative example of making such measurements is set forth in U.S. Pat. No. 5,952,033, which generally instructs as follows: A trial is conduct using a defined number of dogs. The control food is provided, wherein the control food is a commercially available dry dog food (which is nutritionally balanced) which is devoid of short chain oligofructose. A test food is provided which corresponds to the control food except that it includes from about 0.01% to about 0.2% of short chain oligofructose, by weight of the food, as described herein. Half of the dogs are fed the control food and the remaining half are fed the test food. Fecal samples are collected from each dog, heated for 2 hours at 30° C., and the compounds released are trapped on a Tenax tube, or equivalent. The trapped compounds are desorbed on a gas chromatograph. The levels of dimethylsulfide, dimethldisulfide, and dimethyltrisulfide are determined for each of the control and test foods. The results indicate that administration of the test food results in improved fecal odor relative to administration of the control food, as measured by decreases in the levels of dimethylsulfide, dimethldisulfide, and dimethyltrisulfide, which are believed to cause unpleasant odor.

### Methods of Making

The presently described compositions are made according to methods which will be well known by the ordinarily skilled artisan. To illustrate, the compositions of the present invention may be prepared by mixing all components singularly or in suitable combinations together, and in water where appropriate, agitating mechanically until all of the ingredients have been solubilized, dispersed, or otherwise mixed, as applicable. Wherein certain processes such as extrusion (to form kibbles, for example) are utilized, such processes will be well-known in the art.

### EXAMPLES

The following are non-limiting examples of the present compositions which are prepared utilizing conventional methods. The following examples are provided to illustrate the invention and are not intended to limit the scope thereof in any manner.

### Example 1

Two kibble compositions having the following components at the approximate indicated amounts are prepared using methods which are standard in the art and are fed to dogs, each resulting in improved gastrointestinal health and improved fecal odor:

| | Example 1A | Example 1B |
|---|---|---|
| | (Component Amount | (Component Amount |
| Component | indicated as Wt %) | indicated as Wt %) |
| Short Chain Oligofruc- | 0.19 | 0.15 |
| tose (NUTRAFLORA, | | |
| commercially | | |
| available from Golden | | |
| Technologies Company, | | |
| Incorporated | | |
| Poultry, Poultry | 44 | 47 |
| By-product | | |
| Meal, and Fish Meal | | |
| Animal Fat | 8 | 6 |
| Beet Pulp | 2 | 3 |
| Salts | 2.5 | 2 |
| Vitamins and Minerals* | 1 | 1 |
| Minors | 3.5 | 4 |
| Grains | Remainder | Remainder |
| (corn, sorghum, | | |
| barley, rice) | | |

*Vitarnjns and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

### Example 2

A study is designed to determine the effective inclusion level of short chain oligofructose in the companion animal diet.

Healthy adult dogs (n=57) are randomized in a cross-over design to receive one or two experimental protocols: 1) 21 days of EUKANUBA Adult Maintenance (EAM) diet having 0% short chain oligofructose followed by 28 days of EAM including 0.15%, by weight, of short chain oligofructose (n=29) or 2) 21 days of EAM including 0.25%, by weight, of short chain oligofructose (n=28). Fresh fecal samples are collected and enumerated by conventional microbiological plating techniques for Lactobacilli, E. coli, Eubacteria, and Bacteriodes.

Short chain oligofructose fed at 0.15% or 0.25% each reduce (each P<0.05, relative to baseline) fecal concentrations of Bacteriodes after 14 and 28 days of short chain oligofructose feeding. Additionally, short chain oligofructose fed at 0.15% or 0.25% each increase (each P<0.05, relative to baseline) fecal concentrations of Lactobacilli after 14 days of short chain oligofructose feeding. A trending reduction in fecal E. coli is noted after 28 days of feeding for both levels. Demonstrations in improved fecal odor for feedings at both levels are also apparent, even after 14 days of feeding.

This demonstrates that decreased levels of short chain oligofructose are surprisingly useful for the purposes of improving gastrointestinal health or improving the fecal odor of the feces of a companion animal. This now provides the ability to formulate short chain oligofructose into new innovative companion animal compositions at lower cost, the associated cost savings providing for more widespread use of short chain oligofructose than would have been previously expected.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A companion animal composition comprising from about 0.01% to about 0.2% of short chain oligofructose, by weight of the composition, wherein the short chain oligofructose comprises 1-kestose, nystose, and 1F-beta-fructofuranosylnystose.

2. The companion animal composition according to claim 1 wherein the short chain oligofructose comprises from about 30% to about 40% 1-kestose, from about 50% to about 60% nystose, and from about 5% to about 15% 1F-beta-fructofuranosylnystose, by weight of the short chain oligofructose.

3. The companion animal composition according to claim 2 comprising from about 0.05% to about 0.19% of the short chain oligofructose, by weight of the composition.

4. The companion animal composition according to claim 3 further comprising a protein source selected from the group consisting of beef, pork, lamb, poultry, fish, vegetable, and mixtures thereof.

5. The companion animal composition according to claim 4 further comprising a fiber source additional to the short chain oligofructose.

6. The companion animal composition according to claim 5 wherein at least a portion of the fiber source is selected from the group consisting of beet pulp, gum arabic, gum talha, psyllium, rice bran, carob bean gum, citrus pulp, pectin, fructooligosaccharide additional to the short chain oligofructose, mannanoligofructose, soy fiber, arabinogalactan, galactooligosaccharide, arabinoxylan, and mixtures thereof.

7. The companion animal composition according to claim 5 comprising from about 0.1% to about 0.18% of the short chain oligofructose, by weight of the composition.

8. The companion animal composition according to claim 7 which is selected from the group consisting of dry composition, semi-moist composition, wet composition, and mixtures thereof, wherein the composition is nutritionally balanced.

9. A method selected from the group consisting of improving gastrointestinal health of a companion animal, improving fecal odor of the feces of a companion animal, and combinations thereof, comprising administering to the companion animal the companion animal composition according to claim 1.

10. The method according to claim 9 wherein the short chain oligofructose comprises from about 30% to about 40% 1-kestose, from about 50% to about 60% nystose, and from about 5% to about 15% 1F-beta-fructofuranosylnystose, by weight of the short chain oligofructose.

11. The method according to claim 10 wherein the composition comprises from about 0.05% to about 0.19% of the short chain oligofructose, by weight of the composition.

12. The method according to claim 11 wherein the composition further comprises a protein source selected from the group consisting of beef, pork, lamb, poultry, fish, vegetable, and mixtures thereof.

13. The method according to claim 12 wherein the composition comprises from about 0.1% to about 0.18% of the short chain oligofructose, by weight of the composition.

14. The method according to claim 13 wherein the composition is administered at least once daily.

15. The method according to claim 14 wherein the companion animal is selected from the group consisting of dogs, cats, and combinations thereof.

16. The method according to claim 15 wherein small intestine bacterial overgrowth is treated in the companion animal.

17. The method according to claim 15 wherein increased short chain fatty acid concentrations in the feces of the companion animal is exhibited.

18. The method according to claim 15 wherein fecal matter quality is improved in the companion animal.

19. A method of reducing risk of cancer in a companion animal, comprising administering to the companion animal the companion animal composition according to claim 1.

20. The method according to claim 19 wherein the short chain oligofructose comprises from about 30% to about 40% 1-kestose, from about 50% to about 60% nystose, and from about 5% to about 15% 1F-beta-fructofuranosylnystose, by weight of the short chain oligofructose.
